(19) United States
(12) Patent Application Publication
(10) Pub. No.: US 2010/0126481 A1
(43) Pub. Date: May 27, 2010

(54) Engine control system having emissions-based adjustment

(75) Inventors: Martin L. Willi, Dunlap, IL (US); Scott B. Fiveland, Metamora, IL (US); David T. Montgomery, Edelstein, IL (US); Weidong Gong, Dunlap, IL (US)

Correspondence Address: CATERPILLAR/FINNEGAN, HENDERSON, L.L.P., 901 New York Avenue, NW, WASHINGTON, DC, 20001-4413, US

(73) Assignee: CATERPILLAR INC.

(21) Appl. No.: 12/292,826

(22) Filed: Nov. 26, 2008

(51) Int. Cl. F02D 41/00

(52) U.S. Cl. 123/672

(57) ABSTRACT

A control system for an engine having a first cylinder and a second cylinder is disclosed including an air/fuel ratio control device configured to affect an air/fuel ratio within the first and second cylinders. The control system also has a first sensor configured to generate a first signal indicative of a combustion pressure within the first cylinder and a second sensor configured to generate a second signal indicative of a combustion pressure within the second cylinder. The control system further has a controller in communication with the air/fuel ratio control device and the first and second sensors. The controller is configured to determine a NOx production within the first cylinder based on the first signal and determine a NOx production within the second cylinder based on the second signal. The control is also configured to calculate a total NOx production of the engine based on at least the NOx produced within the first and second cylinders and selectively regulate the air/fuel ratio control device to adjust the air/fuel ratio within the first and second cylinders based on the total NOx production of the engine.

### STATEMENT OF GOVERNMENT INTEREST

This invention was made with Government support under Contract No. DE-FC02-01CH11079, awarded by the Department of Energy. The Government may have certain rights in this invention.

### TECHNICAL FIELD

The present disclosure is directed to an engine control system and, more particularly, to an engine control system having emissions-based adjustment.

### BACKGROUND

Combustion engines are often used for power generation applications. These engines can be gaseous-fuel driven and implement lean burn, during which air/fuel ratios are higher than in conventional engines. For example, these gas engines can admit about 75% more air than is theoretically needed for stoichiometric combustion. Lean-burn engines increase fuel efficiency because they utilize homogeneous mixing to burn less fuel than a conventional engine and produce the same power output.

Lean-burn engines typically produce and emit less NOx than conventional combustion engines. In light of increasing government standards for reducing NOx emissions, the ability of lean-burn engines to produce less NOx may provide a significant benefit. However, a shortcoming associated with gaseous-fuel driven engines relates to measuring NOx emissions for purposes of control. Conventional methods for detecting NOx emissions typically require additional components and/or sensors disposed in an exhaust system, which may be inefficient and/or costly.

An exemplary virtual NOx sensor is described in U.S. Pat. No. 6,882,929 B2 (the '929 patent), issued to Liang et al. on Apr. 19, 2005. The '929 patent discloses a process for controlling NOx emissions of a target engine that includes predicting NOx values based on a model reflecting a predetermined relationship between control parameters and NOx emissions. The system of the '929 patent monitors control parameters such as intake manifold temperature and intake manifold pressure. The system inputs the control parameters into the model, which may include a neural network. The model then calculates an estimated NOx emission and provides the data as an output. The system of the '929 patent then adjusts one or more operating parameters of the engine based on the estimated NOx data.

Although the system of the '929 patent may provide ways to calculate and control NOx emissions, the system may be inaccurate. Specifically, the system of the '929 patent utilizes control parameters from outside of the engine's combustion chambers (e.g., intake manifold temperature and pressure), which may not accurately represent the combustion process occurring within the combustion chamber.

The present disclosure is directed to overcoming one or more of the shortcomings set forth above and/or other deficiencies in existing technology.

### SUMMARY OF THE DISCLOSURE

In accordance with one aspect, the present disclosure is directed toward a control system for an engine having a first cylinder and a second cylinder. The control system includes an air/fuel ratio control device configured to affect an air/fuel ratio within the first and second cylinders. The control system also includes a first sensor configured to generate a first signal indicative of a combustion pressure within the first cylinder, and a second sensor configured to generate a second signal indicative of a combustion pressure within the second cylinder. The control system further includes a controller in communication with the air/fuel ratio control device and the first and second sensors. The controller is configured to determine a NOx production within the first cylinder based on the first signal, and to determine a NOx production within the second cylinder based on the second signal. The controller is also configured to calculate a total NOx production of the engine based on at least the NOx produced within the first and second cylinders, and to selectively regulate the air/fuel ratio control device to adjust the air/fuel ratio within the first and second cylinders based on the total NOx production of the engine.

According to another aspect, the present disclosure is directed toward a method of operating an engine. The method includes sensing a parameter indicative of a first combustion pressure within a first cylinder of the engine, and determining a NOx production within the first cylinder based on the first combustion pressure. The method also includes sensing a parameter indicative of a second combustion pressure within a second cylinder of the engine, and determining a NOx production within the second cylinder based on the second combustion pressure. The method further includes calculating a total NOx production of the engine based on at least the NOx produced within the first cylinder and the NOx produced within the second cylinder, and selectively adjusting an air/fuel ratio within the first and second cylinders based on the total NOx production.

### BRIEF DESCRIPTION OF THE DRAWING

FIG. 1 is a schematic illustration of an exemplary disclosed power system.

### DETAILED DESCRIPTION

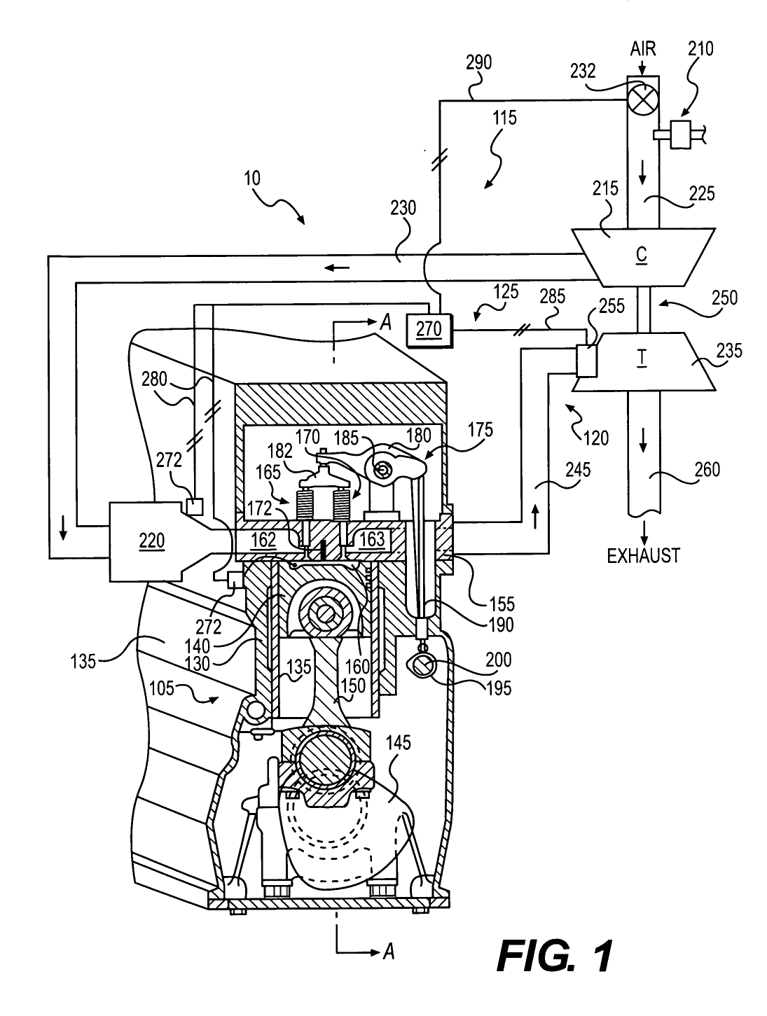

An exemplary disclosed power system 10 is disclosed in FIG. 1. Power system 10 may include an engine 105, an intake system 115, an exhaust system 120, and a control system 125. Intake system 115 may deliver air and/or fuel to engine 105, while exhaust system 120 may direct combustion gases from engine 105 to the atmosphere. Control system 125 may control an operation of intake system 115 and/or exhaust system 120.

Engine 105 may be a four-stroke diesel, gasoline, or gaseous fuel-powered engine. As such, engine 105 may include an engine block 130 at least partially defining a plurality of cylinders 135. It is contemplated that engine 105 may include any number of cylinders 135 and that cylinders 135 may be disposed in an “in-line” configuration, a “V” configuration, or in any other suitable configuration.

A piston 140 may be slidably disposed within each cylinder 135, so as to reciprocate between a top-dead-center (TDC) position and a bottom-dead-center (BDC) position during an intake stroke, a compression stroke, a combustion or power stroke, and an exhaust stroke. Pistons 140 may be operatively connected to a crankshaft 145 via a plurality of connecting rods 150. Crankshaft 145 may be rotatably disposed within engine block 130, and connecting rods 150 may connect each piston 140 to crankshaft 145 so that a reciprocating motion of each piston 140 results in a rotation of crankshaft 145. Similarly, a rotation of crankshaft 145 may result in a sliding motion of each piston 140 between the TDC and BDC positions.

One or more cylinder heads 155 may be connected to engine block 130 to form a plurality of combustion chambers 160. As shown in FIG. 1, cylinder head 155 may include a plurality of intake passages 162 and exhaust passages 163 integrally formed therein. One or more intake valves 165 may be associated with each cylinder 135 and movable to selectively block flow between intake passages 162 and combustion chambers 160. One or more exhaust valves 170 may also be associated with each cylinder 135 and movable to selectively block flow between combustion chambers 160 and exhaust passages 163. Additional engine components may be disposed in cylinder head 155 such as, for example, a plurality of spark plugs 172 that ignite an air/fuel mixture in combustion chambers 160.

Engine 105 may include a plurality of valve actuation assemblies 175 that affect movement of intake valves 165 and/or exhaust valves 170. Each cylinder 135 may have an associated valve actuation assembly 175. Each valve actuation assembly 175 may include a rocker arm 180 connected to move a pair of intake valves 165 and/or a pair of exhaust valves 170 via a bridge 182. Rocker arm 180 may be mounted to cylinder head 155 at a pivot point 185, and connected to a rotating camshaft 200 by way of a push rod 190. Camshaft 200 may be operatively driven by crankshaft 145 to cyclically open and close intake valves 165 and exhaust valves 170, and may include a plurality of cams 195 that engage and move push rods 190.

Intake system 115 may direct air and/or fuel into combustion chambers 160, and may include a single fuel injector 210, a compressor 215, an intake manifold 220, and a throttle valve 232. Compressor 215 may compress and deliver a mixture of air and fuel from fuel injector 210 to intake manifold 220. Throttle valve 232 may vary an amount of air delivered to intake manifold 220 and fuel injector 210 may vary an amount of fuel delivered to intake manifold 220.

Compressor 215 may draw ambient air into intake system 115 via a conduit 225, compress the air, and deliver the compressed air to intake manifold 220 via a conduit 230. In some embodiments, fuel injector 210 may inject fuel into the air flow prior to compression such that the air/fuel mixture is compressed by compressor 215. This delivery of compressed air or air/fuel mixture may help to overcome a natural limitation of combustion engines by eliminating an area of low pressure within cylinders 135 created by a downward stroke of pistons 140. Therefore, compressor 215 may increase the volumetric efficiency within cylinders 135, allowing more air/fuel mixture to be burned, resulting in a larger power output from engine 105. It is contemplated that a cooler for further increasing the density of the air/fuel mixture may be associated with compressor 215, if desired.

Fuel injector 210 may be an air/fuel ratio control device for injecting fuel at a low pressure into conduit 225, upstream of compressor 215, to form an air/fuel mixture. Fuel injector 210 may be selectively modulated by control system 125 to inject an amount of fuel into intake system 115 to substantially achieve a desired air/fuel ratio of the air/fuel mixture. When the amount of fuel injected by fuel injector 210 increases, while the amount of air flow remains constant, the air/fuel ratio may decrease. When the amount of fuel injected by fuel injector 210 decreases, while the amount of air flow remains constant, the air/fuel ratio may increase. Air/fuel ratios appropriate for lean burn engines may be, for example, between about 20:1 to about 65:1.

Throttle valve 232 may also be an air/fuel ratio control device for controlling an amount of air flow through conduit 225. Throttle valve 232 may be any suitable valve for varying air flow such as, for example, a butterfly valve or other variable restriction valve. Throttle valve 232 may be located upstream of compressor 215 and selectively modulated by control system 125 to vary air flow into intake system 115 to substantially achieve the desired air/fuel ratio of the air/fuel mixture. When the air flow through intake system 115 is increased via throttle valve 232, while the amount of fuel injected remains constant, the air/fuel ratio may increase. When the air flow through intake system 115 is decreased via throttle valve 232, while the amount of fuel injected remains constant, the air/fuel ratio may decrease.

Exhaust system 120 may direct exhaust gases from engine 105 to the atmosphere. Exhaust system 120 may include a turbine 235 connected to exhaust passages 163 of cylinder head 155 via a conduit 245. Exhaust gas flowing through turbine 235 may cause turbine 235 to rotate. Turbine 235 may then transfer this mechanical energy to drive compressor 215, where compressor 215 and turbine 235 form a turbocharger 250. In one embodiment, turbine 235 may include a variable geometry arrangement 255 such as, for example, variable position vanes or a movable nozzle ring. Variable geometry arrangement 255 may also be considered an air/fuel ratio control device and may be adjusted to affect the pressure of air/fuel mixture delivered by compressor 215 to intake manifold 220. In embodiments where fuel injector 210 is located downstream of compressor 215, an increase in the pressure of air affected via variable geometry arrangement 255 may cause more air to be delivered to cylinders 135, resulting in an increase of the air/fuel ratio. In contrast, a decrease in the pressure of air affected via variable geometry arrangement 255 may cause less air to be delivered to cylinders 135, resulting in a decrease of the air/fuel ratio. Turbine 235 may be connected to an exhaust outlet via a conduit 260. It is also contemplated that turbocharger 250 may be replaced by any other suitable forced induction system known in the art such as, for example, a supercharger, if desired.

The air/fuel ratio of the air/fuel mixture that is delivered to cylinders 135 may affect the amount of NOx produced by engine 105. As the air/fuel ratio increases (i.e., becomes leaner), a combustion flame within combustion chamber 160 may become well-distributed, causing the air/fuel mixture to burn at a lower temperature. This lower temperature may slow the chemical reaction of the combustion process, thereby decreasing NOx production. Therefore, as the air/fuel ratio increases, NOx production may decrease. In contrast, as the air/fuel ratio decreases, the amount of NOx produced by engine 105 may increase (i.e., as combustion becomes less lean, NOx production may increase).

Control system 125 may include a controller 270 configured to modulate the air/fuel ratio control devices of power system 10 in response to input from one or more sensors 272. Sensors 272 may be configured to monitor an engine parameter indicative of NOx production within cylinders 135. In one example, the engine parameter may be a combustion pressure within cylinders 135. Each sensor 272 may be disposed within an associated cylinder 135 (i.e., in fluid contact with a respective one of combustion chambers 160), and may be electrically connected to controller 270. Sensor 272 may be any suitable sensing device for sensing an in-cylinder pressure such as, for example, a piezoelectric crystal sensor or a piezoresistive pressure sensor. Sensors 272 may measure a pressure within cylinders 135 during, for example, the compression stroke and/or the power stroke, and may generate a corresponding signal. Sensors 272 may transfer signals that are indicative of the pressures within cylinders 135 to controller 270. Based on these signals, controller 270 may determine NOx production for each cylinder 135 and, subsequently, a total NOx production of engine 105. Based on the total NOx production, controller 270 may then control the air/fuel ratio control devices such that NOx production is at a desired amount.

Controller 270 may be any type of programmable logic controller known in the art for automating machine processes, such as a switch, a process logic controller, or a digital circuit. Controller 270 may serve to control the various components of power system 10. Controller 270 may be electrically connected to the plurality of sensors 272 via a plurality of electrical lines 280. Controller 270 may also be electrically connected to variable geometry arrangement 255 via an electrical line 285 and to an actuator of throttle valve 232 via an electrical line 290. It is also contemplated that controller 270 may be electrically connected to additional components and sensors of power system 10 such as, for example, an actuator of fuel injector 210, if desired.

Controller 270 may include input arrangements that allow it to monitor signals from the various components of power system 10 such as sensors 272. Controller 270 may rely upon digital or analog processing of input received from components of power system 10 such as, for example, sensors 272 and an operator interface. Controller 270 may utilize the input to create output for controlling power system 10. Controller 270 may include output arrangements that allow it to send output commands to the various components of power system 10 such as variable geometry arrangement 255, fuel injector 210, throttle valve 232 and/or an operator interface that includes a signaling device to alert the operator of an engine status.

Controller 270 may have stored in memory one or more engine maps and/or algorithms. Controller 270 may reference these maps to determine a required change in operation of the air/fuel ratio control devices required to affect the desired NOx production and emission and/or a capacity of the air/fuel ratio control devices for the modification. Each of these maps may include a collection of data in the form of tables, graphs, and/or equations.

Controller 270 may have stored in memory algorithms associated with determining required changes in operation of the air/fuel ratio control devices based on engine parameters such as, for example, combustion pressure. For example, controller 270 may include an algorithm that performs a statistical analysis of the combustion pressures within the plurality of cylinders 135 from combustion cycle to combustion cycle. Based on input received from sensors 272, the algorithm may determine, for example, an average NOx production per combustion cycle for each cylinder 135 and/or for all of cylinders 135. The algorithm may also determine the statistical deviation of the NOx production of each cylinder 135 from the average NOx production of all of cylinders 135.

In one example, controller 270 may have a stored algorithm for determining a heat release profile of each cylinder 135 based on the measured cylinder pressures. Controller 270 may then use the heat release values in the algorithm to determine a temperature level in combustion chamber 160 over time (i.e., a time temperature history). Controller 270 may use the time temperature histories of the plurality of cylinders 135 in the algorithm to determine an estimate of total NOx production from cylinders 135.

Based on the determined estimate of total NOx production, controller 270 may determine a desired air/fuel ratio for engine 105. Controller 270 may have stored in memory one or more engine maps identifying desired NOx production levels that may correspond, for example, to emissions standards. Controller 270 may have stored in memory one or more engine maps that relate varying levels of total NOx production to corresponding air/fuel ratios of the air/fuel mixture delivered to cylinders 135. Based on these engine maps, controller 270 may identify when a determined estimate of total NOx production exceeds a desired amount of NOx production, and then select a desired air/fuel ratio that corresponds to the desired NOx production. Controller 270 may control the air/fuel control devices to adjust the air/fuel ratio to the desired air/fuel ratio, thereby adjusting the NOx production toward the desired NOx production.

In another example, controller 270 may also have a stored algorithm for determining an operational status of an engine component based on input from sensors 272 such as, for example, based on the average combustion pressure, the heat release history, and/or the NOx production. Controller 270 may use the signals from sensors 272 as input to an algorithm that compares the parameters of a given cylinder 135 to expected parameters for that cylinder 135 at various times during the combustion cycle. Based on the comparison, controller 270 may identify, for example, a parameter difference that is indicative of a leak of mass from cylinder 135 or poor/improper combustion. For example, the difference in the parameter may be caused by a leaking intake valve 165 and/or exhaust valve 170, a broken piston ring, or a non-functioning spark plug 172, such that combustion does not occur or is poor.

In another example, controller 270 may have a stored algorithm for determining an operational status of an engine component based on a statistical deviation of the parameter in one cylinder 135 from an average parameter for all of cylinders 135. Controller 270 may use the signals from sensors 272 as input to an algorithm that compares the measured parameter of each cylinder 135 to the measured or historical parameters of the remainder of cylinders 135. Controller 270 may calculate an average parameter for the plurality of cylinders 135 and compare the measured parameter of each cylinder 135 to that average parameter. Additionally, controller 270 may compare the measured parameter of each cylinder 135 to a calculated theoretical average parameter for all of cylinders 135. Controller 270 may determine a statistical deviation of the parameter of each cylinder 135 from the average parameter to identify a cylinder 135 having a malfunctioning component. For example, sensor 272 may indicate to controller 270 that a given cylinder 135 has a parameter that significantly deviates from the average parameter, indicating a malfunction.

Based on output from one or more algorithms indicative of NOx production and/or operational status, controller 270 may vary an air/fuel ratio of the air/fuel mixture that is delivered to cylinders 135. Controller 270 may control fuel injector 210, throttle valve 232, variable geometry arrangement 255 of turbine 235, and/or other components to achieve the desired air/fuel ratio based on the algorithm output.

### INDUSTRIAL APPLICABILITY

The disclosed engine control system may be used in any machine having a combustion engine where control of NOx production is required. For example, the engine control system may be particularly applicable to gaseous-fuel driven engines that implement lean burn. Operation of power system 10 will now be described.

Sensors 272 may measure a combustion pressure within cylinders 135 and provide the pressure measurements as signals to controller 270. Controller 270 may use signals as input to one or more stored algorithms for determining a total production of NOx from cylinders 135. Based on the NOx production of each cylinder 135 and/or a total NOx production of engine 105, controller 270 may adjust the air/fuel ratio of the mixture provided to each cylinder 135. For example, controller 270 may adjust an amount of fuel injected by fuel injector 210 and/or an amount of air allowed into intake manifold 220 by throttle valve 232 based on the determined NOx production. Controller 270 may also vary a geometry of turbocharger 250 based on the NOx production.

For example, sensors 272 may provide signals indicative of a combustion pressure that is lower than desired to controller 270. Using the signals from sensors 272, controller 270 may use one or more stored algorithms to determine that a NOx production of engine 105 is correspondingly greater than desired. Controller 270 may control the air/fuel ratio control devices to increase the air/fuel ratio of the air/fuel mixture entering cylinders 135, thereby decreasing NOx emissions toward a desired level. For example, fuel injector 210 may inject less fuel, throttle valve 232 may increase air flow, and/or turbocharger 250 may increase the pressure of air delivered to cylinders 135. In contrast, sensors 272 may provide signals indicative of a combustion pressure that is higher than desired to controller 270. Using the signals from sensors 272, controller 270 may use one or more stored algorithms to determine that a NOx production of engine 105 is correspondingly lower than required. Controller 270 may control the air/fuel ratio control devices to decrease the air/fuel ratio of the air/fuel mixture entering cylinders 135, thereby increasing NOx emissions toward a desired level. For example, fuel injector 210 may inject more fuel, throttle valve 232 may decrease air flow, and/or turbocharger 250 may decrease the pressure of air delivered to cylinders 135.

Controller 270 may also use the signals provided from sensors 272 as input to one or more stored algorithms for determining an operational status of an engine component. Based on the operational status output of the algorithms, controller 270 may determine that one or more intake valves 165, exhaust valves 170, spark plugs 172, or piston rings may be malfunctioning. Based on the operational status, controller 270 may, for example, adjust power system 10 to signal the condition to an operator and/or adjust the air/fuel ratio of the air/fuel mixture. Controller 270 may adjust fuel injector 210 or throttle valve 232 of power system 10 to adjust the air/fuel ratio based on the operational status. Controller 270 may also vary a geometry of turbocharger 250 based on the operational status.

For example, sensors 272 may provide signals indicative of a combustion pressure that is lower than desired to controller 270. Using the signals from sensors 272, controller 270 may use one or more stored algorithms to determine that one or more intake valves 165, exhaust valves 170, and/or piston rings are leaking, and thereby lowering combustion pressure. Additionally, when a component is leaking, the power produced by engine 105 may be less than desired. Controller 270 may also determine that a NOx production is higher than desired. Controller 270 may signal the operation status to the operator interface and/or control the air/fuel ratio control devices to increase the air/fuel ratio of the air/fuel mixture entering cylinders 135, thereby decreasing NOx emissions toward a desired level.

In another example, sensors 272 may provide signals indicative of a combustion pressure that is higher than desired to controller 270. Using the signals from sensors 272, controller 270 may use one or more stored algorithms to determine that one or more intake valves 165 and/or exhaust valves 170 are operating improperly (e.g., valve timing is improper), and/or one or more spark plugs 172 are firing at an improper timing, thereby increasing combustion pressure. Controller 270 may also determine that a NOx production is lower than desired. Controller 270 may signal the operation status to the operator interface and/or control the air/fuel ratio control devices to decrease the air/fuel ratio of the air/fuel mixture entering cylinders 135, thereby increasing NOx emissions toward a desired level.

Because in-cylinder measurements may be reliable indicators of NOx emissions, controller 270 may accurately estimate NOx production. Controller 270 may also use this accurate NOx estimate to adjust the operation of power system 10 such that NOx emissions are maintained at a desired level. Controller 270 may also use in-cylinder measurements to determine an operational status of components of power system 10, thereby providing an efficient diagnostic tool for extending a service life of power system 10.

It will be apparent to those skilled in the art that various modifications and variations can be made to the disclosed apparatus and method. Other embodiments will be apparent to those skilled in the art from consideration of the specification and practice of the disclosed method and apparatus. It is intended that the specification and examples be considered as exemplary only, with a true scope being indicated by the following claims and their equivalents.

What is claimed is:

1. A control system for an engine having a first cylinder and a second cylinder, the control system comprising:
an air/fuel ratio control device configured to affect an air/fuel ratio within the first and second cylinders;
a first sensor configured to generate a first signal indicative of a combustion pressure within the first cylinder;
a second sensor configured to generate a second signal indicative of a combustion pressure within the second cylinder; and
a controller in communication with the air/fuel ratio control device and the first and second sensors, the controller being configured to:
determine a NOx production within the first cylinder based on the first signal;
determine a NOx production within the second cylinder based on the second signal;
calculate a total NOx production of the engine based on at least the NOx produced within the first and second cylinders; and
selectively regulate the air/fuel ratio control device to adjust the air/fuel ratio within the first and second cylinders based on the total NOx production of the engine.

2. The control system of claim 1, wherein the controller is configured to relate the combustion pressure of each of the first and second cylinders to a heat release during combustion, and to determine the NOx productions based on the heat release.

3. The control system of claim 2, wherein the controller is further configured to determine a heat release profile based on the heat release over time.

4. The control system of claim 1, wherein the air/fuel ratio control device is a fuel injector configured to supply fuel to both the first and second cylinders.

5. The control system of claim 1, wherein the air/fuel ratio control device is a throttle valve.

6. The control system of claim 1, wherein the controller is further configured to determine an operational status of an engine component based on the first signal.

7. The control system of claim 6, wherein the engine component is a spark plug.

8. The control system of claim 6, wherein the engine component is one of an engine valve or a piston ring.

9. The control system of claim 6, wherein the controller is configured to determine an average combustion pressure within the first cylinder based on the first signal, and to determine the operational status of the engine component based on the average combustion pressure.

10. The control system of claim 9, wherein:
the controller is further configured to:
determine the average combustion pressure within the second cylinder based on the second signal; and
compare the average combustion pressure within the first cylinder with the average combustion pressure within the second cylinder; and
the operational status of the engine component is determined based on the comparison of the average combustion pressures of the first and second cylinders.

11. A method of operating an engine, comprising:
sensing a parameter indicative of a first combustion pressure within a first cylinder of the engine;
determining a NOx production within the first cylinder based on the first combustion pressure;
sensing a parameter indicative of a second combustion pressure within a second cylinder of the engine; and
determining a NOx production within the second cylinder based on the second combustion pressure;
calculating a total NOx production of the engine based on at least the NOx produced within the first cylinder and the NOx produced within the second cylinder; and
selectively adjusting an air/fuel ratio within the first and second cylinders based on the total NOx production.

12. The method of claim 11, wherein a controller is configured to relate the combustion pressure of each of the first and second cylinders to a heat release during combustion, and to determine the NOx productions based on the heat release.

13. The method of claim 12, further including determining a heat release profile based on the heat release over time.

14. The method of claim 11, wherein selectively adjusting the air/fuel ratio within the first and second cylinders includes adjusting an amount of fuel supplied to both the first and the second cylinders.

15. The method of claim 11, wherein selectively adjusting the air/fuel ratio within the first and second cylinders includes adjusting an amount of air supplied to both the first and second cylinders.

16. The method of claim 11, further including determining an operational status of an engine component based on the first combustion pressure.

17. The method of claim 16, wherein the engine component is one of a spark plug, an engine valve, or a piston ring.

18. The method of claim 16, further including determining an average combustion pressure within the first cylinder based on the first combustion pressure, wherein determining the operational status of the engine component includes determining the operational status of the engine component based on the average combustion pressure.

19. The method of claim 18, further including:
determining an average combustion pressure within the second cylinder based on the second combustion pressure; and
comparing the average combustion pressure within the first cylinder with the average combustion pressure within the second cylinder,
wherein determining the operational status of the engine component includes determining the operational status based on the comparison of the average combustion pressures of the first and second cylinders.

20. A power system, comprising:
an air/fuel ratio control device; and
an engine having:
a first cylinder;
a first sensor configured to generate a first signal indicative of combustion pressure within the first cylinder;
a second cylinder; and
a second sensor configured to generate a first signal indicative of a combustion pressure within the second cylinder; and
a controller in communication with the air/fuel ratio control device and the first and second sensors, the controller being configured to:
determine a NOx production within the first cylinder based on the first signal;
determine a NOx production within the second cylinder based on the second signal;
calculate a total NOx production based on at least the NOx produced within the first cylinder and the NOx produced within the second cylinder; and
selectively regulate the air/fuel ratio control device to adjust an air/fuel ratio within the first and second cylinders based on the total NOx production.
